(19) United States
(12) Patent Application Publication
(10) Pub. No.: US 2022/0154017 A1
(43) Pub. Date: May 19, 2022

(54) ALKALI RELEASE SOLUTION FOR GRAVURE PRINTING INK COMPOSITIONS AND RELEASE METHOD USING THE SAME

(71) Applicant: INX INTERNATIONAL INK CO., Schaumburg, IL (US)

(72) Inventors: Mark David HILL, Appleton, WI (US); Sei EZUMI, Schaumburg, IL (US); Kim Marie HILL, Appleton, WI (US); Kristina Lynn BREITLING, Saint Charles, IL (US); Yusuke NAKAJIMA, Schaumburg, IL (US)

(21) Appl. No.: 16/952,039

(22) Filed: Nov. 18, 2020

(51) Int. Cl. C09D 9/04; C09D 11/033; B41M 7/00

(52) U.S. Cl. CPC C09D 9/04; B41M 2205/18; B41M 7/0009; C09D 11/033

(57) ABSTRACT

An alkali release solution contains a basic compound, a polyoxyalkylene alkyl derivative, and water, for releasing a printed layer formed on a base material and constituted by a gravure printing ink composition for label surface printing that satisfies a or b below: a) containing no vinyl chloride resin, wherein the composition contains a pigment, a binder resin containing cellulose resin and urethane resin, and an organic solvent, wherein the ratio by mass of the solids content of polyurethane resin and cellulose resin is 5/95 to 95/5; or b) containing a vinyl chloride resin, the composition contains a pigment, a vinyl chloride resin, and a polyurethane resin, wherein the content of the vinyl chloride resin, based on the ratio by mass of the solids content of vinyl chloride resin and urethane resin, is 1.73 parts by mass or lower relative to the urethane resin representing 1.00 part by mass.

### FIELD

The present invention relates to an alkali release solution for gravure printing ink compositions and a release method using such alkali release solution.

### BACKGROUND

Packaging materials comprising various plastic films are used for food, confectioneries, articles for daily use, pet food, etc., from the viewpoints of design, economy, protection of content, transportability, etc. Also, many packaging materials are gravure-printed or flexo-printed to add design elements and messages that appeal to consumers.

To obtain these packaging materials, the top or bottom surfaces of base films for packaging materials are printed on without receiving further treatment, or, if necessary, the printed surfaces of the base films for packaging materials are coated with an adhesive or anchoring agent and then the films are laminated.

In terms of printing, polyester, nylon, aluminum foil, and various other films are printed with colored inks and then with white ink, after which a polyethylene film, polypropylene film, etc., is layered on top of each such printed layer of white ink by means of dry lamination using an adhesive, extrusion lamination using an anchoring-coating agent, or the like, for the purpose of heat sealing (refer to Japanese Patent Laid-open No. Hei 5-97959).

A method whereby a release primer layer is formed on a polyester base material beforehand and then a printed layer is formed on top to allow the printed layer to be released, is of public knowledge (refer to Japanese Patent No. 6388131). Based on this method, however, immersing a printed matter that has been shredded together with its release primer layer, in an aqueous solution of sodium hydroxide, causes the release primer to contact the aqueous solution of sodium hydroxide only along the cross-sections of the shredded printed matter. Accordingly, the release primer layer will demonstrate its release property only after the aqueous solution of sodium hydroxide permeates it from these cross-sections. Since this permeation takes time, the printed layer cannot be released quickly. Also, because the release primer layer dissolves in the aqueous solution of sodium hydroxide, disposing of the aqueous solution of sodium hydroxide after use may become troublesome.

### SUMMARY OF THE INVENTION

An object of the present invention is to provide an alkali release solution that, with respect to a used printed matter comprising a shrink PET, etc., on which a gravure printing ink composition has been printed, allows the part printed with the ink composition to be released at will and quickly, as well as a method for releasing the ink composition part from the printed matter using such alkali release solution.

As a result of studying in earnest to achieve the aforementioned object, the inventors of the present invention invented the alkali release solution, and method for releasing an ink composition layer using such alkali release solution, as described below:

1. An alkali release solution containing a basic compound, a polyoxyalkylene alkyl derivative, and water, for releasing a printed layer formed on a base material and constituted by a gravure printing ink composition for label surface printing that satisfies a or b below: a) when the gravure printing ink composition for label surface printing does not contain vinyl chloride resin, it is a gravure printing ink composition for label surface printing that contains a pigment, a binder resin containing cellulose resin and urethane resin, and an organic solvent, wherein the ratio by mass of the solids content of polyurethane resin and cellulose resin is 5:95 to 95:5 (polyurethane resin : cellulose resin); or, b) when the gravure printing ink composition for label surface printing contains a vinyl chloride resin, it is a gravure printing ink composition for label surface printing that contains a pigment, a vinyl chloride resin, and a polyurethane resin, wherein the content of the vinyl chloride resin, based on the ratio by mass of the solids content of vinyl chloride resin and urethane resin, is 1.73 parts by mass or lower relative to the urethane resin representing 1.00 part by mass.

2. The alkali release solution for gravure printing ink compositions for label surface printing according to 1, wherein the polyoxyalkylene alkyl derivative is a polyoxyalkylene alkyl phenyl ether.

3. The alkali release solution according to 1, wherein the basic compound is contained by 0.5 to 15.0 percent by mass and the polyoxyalkylene alkyl derivative is contained by 0.01 to 3.0 percent by mass.

4. The alkali release solution according to 2, wherein the basic compound is contained by 0.5 to 15.0 percent by mass and the polyoxyalkylene alkyl derivative is contained by 0.01 to 3.0 percent by mass.

5. A method for releasing for a printed layer formed on a shrink PET base material and constituted by a gravure printing ink composition for label surface printing that satisfies a or b below, using an alkali release solution containing a basic compound, a polyoxyalkylene alkyl derivative, and water: a) when the gravure printing ink composition for label surface printing does not contain vinyl chloride resin, it is a gravure printing ink composition for label surface printing that contains a pigment, a binder resin containing cellulose resin and urethane resin, and an organic solvent, wherein the ratio by mass of the solids content of polyurethane resin and cellulose resin is 5:95 to 95:5 (polyurethane resin : cellulose resin); or, b) when the gravure printing ink composition for label surface printing contains a vinyl chloride resin, it is a gravure printing ink composition for label surface printing that contains a pigment, a vinyl chloride resin, and a polyurethane resin, wherein the content of the vinyl chloride resin, based on the ratio by mass of the solids content of vinyl chloride resin and urethane resin, is 1.73 parts by mass or lower relative to the urethane resin representing 1.00 part by mass.

6. The method for releasing according to 5, wherein the polyoxyalkylene alkyl derivative is a polyoxyalkylene alkyl phenyl ether.

7. The method for releasing according to 5, wherein the basic compound is contained by 0.5 to 15.0 percent by mass and the polyoxyalkylene alkyl derivative is contained by 0.01 to 3.0 percent by mass.

8. The method for releasing according to 6, wherein the basic compound is contained by 0.5 to 15.0 percent by mass and the polyoxyalkylene alkyl derivative is contained by 0.01 to 3.0 percent by mass.

According to the alkali release solution and method for releasing an ink composition layer using such alkali release solution, as proposed by the present invention, an ink layer formed on a shrink PET film or other base material can be released without fail.

### DETAILED DESCRIPTION

The alkali release solution proposed by the present invention is explained in greater detail below.

### Alkali Release Solution

The alkali release solution proposed by the present invention contains a basic compound, a polyoxyalkylene alkyl derivative, and water.

### Basic Compound

Under the present invention, the basic compound is not contained in any way and may be an inorganic compound such as sodium hydroxide, potassium hydroxide, or other alkali hydroxide metal salt, or calcium hydroxide or other alkali hydroxide earth metal salt, or it may be an organic amine such as alkylamine or alkylenediamine. It should be noted, however, that the basic compound must be soluble in water.

The content of the basic compound in the alkali release solution for gravure printing ink compositions only needs to be in a range that allows the alkali release solution to exhibit sufficient basicity, which is preferably 0.5 to 15.0 percent by mass, or more preferably 1.0 to 10.0 percent by mass. When the concentration of the basic compound is within the aforementioned range, the alkali release solution can maintain enough alkalinity required for releasing. It should be noted that, from the viewpoints of environmental considerations and handling of effluent in the recycling process, preferably the concentration of the alkali release solution is 5.0 percent by mass or lower.

### Polyoxyalkylene Alkyl Derivative

Under the present invention, the polyoxyalkylene alkyl derivative is a compound containing a polyoxyalkylene group and an alkyl group. Preferably it is one in which the polyoxyalkylene group and alkyl group are bonded to the same benzene ring.

The content of the polyoxyalkylene alkyl derivative in the alkali release solution for gravure printing ink compositions for label surface printing only needs to be in a range that allows the effect of containing the polyoxyalkylene alkyl derivative to be demonstrated fully, which is preferably 0.01 to 3.0 percent by mass, or more preferably 0.5 to 2.0 percent by mass.

Such compound is able to demonstrate surface activity because one end of its molecule is hydrophilic, while the other end is hydrophobic. The degree is such that its HLB is preferably 7.0 or higher, or more preferably 10.0 or higher.

Preferably the polyoxyalkylene group in such polyoxyalkylene alkyl derivative is a polyoxyethylene group or polyoxypropylene group. The number of repetitions of such group is preferably 5 to 20, or more preferably 7 to 13.

In the meantime, the alkyl group may be of straight-chain type or branched-chain type, but preferably it is of branched-chain type. The carbon number of the alkyl group is preferably 3 to 12, or more preferably 5 to 10.

For example, a polyoxyalkylene alkyl phenyl ether, or specifically polyethylene glycol (10) octyl phenyl ether, poly(oxyethylene) nonyl phenyl ether, etc., may be used.

Such compound is preferably the one shown below:

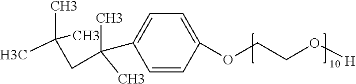

The ink composition primarily intended to be released by the alkali release solution and method for releasing an ink composition layer using such alkali release solution, as proposed by the present invention, principally contains the components below.

### Pigment

Usable pigments include various inorganic pigments and/or organic pigments, etc., generally used in printing inks.

The inorganic pigments include titanium oxide, red iron oxide, antimony red, cadmium yellow, cobalt blue, Prussian blue, ultramarine blue, carbon black, graphite, and other colored pigments, as well as silica, calcium carbonate, kaolin, clay, barium sulfate, aluminum hydroxide, talc, and other extender pigments.

The organic pigments include soluble azo pigments, insoluble azo pigments, azo lake pigments, condensed azo pigments, copper phthalocyanine pigments, condensed polycyclic pigments, and the like.

Under the present invention, preferably the content of the pigment is 0.5 to 50.0 percent by mass in the gravure printing ink composition. When the content of the pigment in the gravure printing ink composition is below the aforementioned range, the coloring strength of the gravure printing ink composition drops, while a content exceeding the aforementioned range increases the viscosity of the gravure printing ink composition and makes the printed matter vulnerable to smudges.

### Binder Resin

The binder resin may be a binder resin containing cellulose resin and urethane resin, or a binder resin containing vinyl chloride resin and urethane resin. It should be noted that the ratio by mass of the solids content of cellulose resin and urethane resin is preferably 1:9 to 9:1 (cellulose resin : urethane resin), or the ratio by mass of the solids content of vinyl chloride resin and urethane resin is preferably 0.5:9.5 to 3:7 (vinyl chloride resin:urethane resin).

### Polyurethane Resin

For the polyurethane resin, a polyisocyanate compound, diol compound, or other polyurethane resin obtained by causing such compound to react with a chain extender, reaction terminator, etc., as necessary, may be adopted.

Here, for the polyisocyanate compound, hexamethylene diisocyanate, 2,2,4-trimethyl hexamethylene diisocyanate, or other aliphatic diisocyanate compound, isophorone diisocyanate, hydrogenated xylylene diisocyanate, 4,4-cyclohexyl methane diisocyanate, or other alicyclic diisocyanate compound, xylylene diisocyanate, α,α,α′,α′-tetramethyl xylylene diisocyanate, or other aromatic-aliphatic diisocyanate compound, toluylen diisocyanate, diphenyl methane diisocyanate, or other aromatic diisocyanate compound, etc., may be adopted.

Furthermore, any known binder resin for gravure printing inks may be combined with such polyurethane resin.

Next, a preferred form of the diol compound is a high-molecular diol compound with a number-average molecular weight of greater than 500 but no greater than 3000, or more preferably between 500 and 2000, comprising one type of diol compound or a combination of multiple diol compounds. If the number-average molecular weight of the diol compound is 500 or smaller, the adhesive property tends to drop; if the number-average molecular weight exceeds 3000, on the other hand, the oil resistance tends to drop.

Specific examples of diol compounds include alkylene glycol compounds with a molecular weight of 100 or higher, polyalkylene glycol compounds such as polyethylene glycol and polypropylene glycol, as well as polyether diol compounds obtained by poly-adding an ethylene oxide, propylene oxide, or other oxyalkylene, or tetrahydrofuran, etc., to a low-molecular-weight alkylene glycol, bisphenol, or other diol compound.

Also included in the examples are polyester diol compounds obtained by poly-condensing a low-molecular diol compound (such as ethylene glycol, 1,3-propanediol, 1,4-butanediol, 1,6-hexanediol, or other straight-chain glycol; 1,2-propanediol, neopentyl glycol, 3-methyl-1,5-pentanediol, 2,4-diethyl-1,5-pentanediol, ethyl butyl propanediol, or other branched glycol; diethylene glycol, triethylene glycol, or other ether-based diol), with a dicarboxylic acid compound such as succinic acid, adipic acid, azelaic acid, sebacic acid, maleic acid, or other saturated or unsaturated aliphatic dicarboxylic acid; phthalic acid or other aromatic dicarboxylic acid); as well as polyester diol compounds obtained by ring-opening lactone or other cyclic ester compound.

Furthermore, any straight-chain or side-chain polycarbonate compound, polybutadiene glycol compound, etc., may also be combined.

Additionally, when any aromatic hydrocarbon-based organic solvent (toluene, etc.) is not used in light of environmental consideration, and a system containing a high content of a highly polar organic solvent such as alcohol, ester, and the like is used, a polyether diol compound is preferably used as the polyol compound in order to achieve good printability.

Also, if another solvent is used, it may be preferable to use a polyester diol compound, depending on the circumstances.

Furthermore, a polyurethane resin obtained using a chain extender or reaction terminator can also be used, where the chain extender may be, for example, ethylenediamine, propylenediamine, tetramethylenediamine, hexamethylenediamine, or other aliphatic diamine; isophoronediamine, 4,4′-dicyclohexyl methanediamine, or other alicyclic diamine; diethylenetriamine, triethylenetetratriamine, or other polyamine; toluylenediamine or other aromatic diamine; xylenediamine or other aromatic-aliphatic diamine; N-(2-hydroxyethyl) ethylenediamine, N-(2-hydroxyethyl) propylenediamine, N,N′ -di(2-hydroxyethyl) ethylenediamine, or other diamine having hydroxyl groups; ethylene glycol, propylene glycol, 1,4-butanediol, neopentyl glycol, diethylene glycol, triethylene glycol, or other diol compound.

The reaction terminator may be methanol, ethanol or other monoalcohol, n-propylamine, n-butylamine, di-n-butylamine, or other alkylamine; monoethanolamine, diethanolamine, or other alkanolamine; ethylenediamine, propylenediamine, tetramethylenediamine, hexamethylenediamine, or other aliphatic diamine; isophoronediamine, 4,4′-dicyclohexyl methanediamine, or other alicyclic diamine; diethylenetriamine, triethylenetetratriamine, or other polyamine; toluylenediamine or other aromatic diamine; xylenediamine or other aromatic-aliphatic diamine; N-(2-hydroxyethyl) ethylenediamine, N-(2-hydroxyethyl) propylenediamine, N,N′ -di(2-hydroxyethyl) ethylenediamine, or other diamine having hydroxyl groups; or aminoethyl ethanolamine, and the like.

Using the above synthetic components, a polyurethane resin for use in the present invention can be obtained by first reacting a polyisocyanate compound and a diol compound together so that the molar equivalent ratio of NCO in the polyisocyanate compound and OH in the diol compound (molar equivalent of NCO in the polyisocyanate compound/molar equivalent of OH in the diol compound) becomes 0.5 or higher but no higher than 3.0, or preferably 1.2 or higher but no higher than 1.5, and then allowing the reaction product to react with a chain extender or reaction terminator, as necessary.

It should be noted that, when the molar equivalent of NCO in the polyisocyanate compound/molar equivalent of OH in the diol compound is lower than 0.5, the heat resistance and oil resistance tend to drop; whereas, when the molar equivalent of NCO in the polyisocyanate compound/molar equivalent of OH in the diol compound exceeds 3, the stretchability tends to drop.

Also, the polyurethane resin may or may not have an acid value.

### Biomass Polyurethane

The diol compound constituting the polyurethane may, in part or in whole, be a diol compound obtained using a plant-derived biomass component in consideration of the environment.

Such diol compound is preferably a polyester polyol compound, and for this polyester polyol compound, a bio-polyester polyol (biomass polyester polyol) resulting from reacting a short-chain diol compound with carbon number 2 to 4 and a carboxylic acid compound, may be adopted. As for the bio-polyol components, preferably at least one of the short-chain diol compound and carboxylic acid compound is plant-derived, or more preferably both are plant-derived.

The plant-derived short-chain diol compound with carbon number 2 to 4 is not limited in any way. For example, the short-chain diol compound may be a 1,3-propanediol, 1,4-butanediol, ethylene glycol, etc., obtained from a plant material according to the following method. These may be used in combination.

A 1,3-propanediol can be manufactured from a glycerol, by way of a 3-hydroxypropyl aldehyde (HPA), according to the fermentation method whereby a plant resource (such as corn, etc.) is broken down to obtain a glucose. A 1,3-propanediol component manufactured per a biological method, such as the aforementioned fermentation method, is superior in safety to a 1,3-propanediol component based on the EO manufacturing method and can provide useful biproducts such as lactic acid and also keep the manufacturing cost low. A 1,4-butanediol can be manufactured by manufacturing a glycol from a plant resource, fermenting the glycol to obtain a succinic acid, and then hydrogenating the succinic acid. Also, an ethylene glycol can be manufactured from a bioethanol obtained according to a conventional method, by way of an ethylene.

The plant-derived carboxylic acid compound is not limited in any way. For example, the carboxylic compound may be sebacic acid, succinic acid, lactic acid, glutaric acid, dimer acid, etc. These may be used in combination. Preferably the carboxylic compound contains at least one type of acid selected from the group that includes sebacic acid, succinic acid, and dimer acid, among the foregoing. Also, malic acid may be contained by 0.05 to 0.5 parts by mass relative to 100 parts by mass of sebacic acid.

The bio-polyester polyol compound is produced, as a 100 percent plant-derived bio-polyester polyol, by condensation-reacting a plant-derived short-chain diol compound and a plant-derived carboxylic acid as deemed appropriate. To be specific, it is obtained as a polytrimethylene sebacate polyol by directly dehydration-condensing a plant-derived sebacic acid and a plant-derived 1,3-propane diol. Or, it is obtained as a polybutylene succinate polyol by directly dehydration-condensing a plant-derived succinic acid and a plant-derived 1,4-butane diol.

One or more types of these bio-polyester polyol compounds may be used.

The urethane prepolymer obtained from these plant-derived components may be contained by 10 percent by mass or more, or 40 percent by mass or more, in terms of solids content, of all urethane prepolymers.

Even when plant-derived components are used, as described above, the same chain extenders and reaction terminators mentioned above can still be used.

### Cellulose Resin

For the cellulose resin, any of the cellulose resins traditionally used in gravure printing ink compositions for surface printing may be used. Such cellulose resins include nitrocellulose (nitro group substituent), cellulose acetate, cellulose acetate propionate, cellulose acetate butyrate (CAB) and other lower acyl group substituents, as well as methyl cellulose, ethyl cellulose, and other lower alkyl group substituents. Under the present invention, these cellulose resins may be used without problem so long as their molecular weight and degree of substitution with respect to hydroxyl groups are within the ranges used in standard ink compositions and coating materials.

In general, a substitution degree of approx. 1.3 to 2.7 with respect to hydroxyl groups is preferred. Also, using a nitro group substituent is advantageous in terms of heat resistance, while a lower acyl group substituent or lower alkyl group substituent is advantageous in terms of adhesive property, which means that preferably a selection should be made as deemed appropriate according to the purpose.

When a cellulose resin is contained, the content ratio of the polyurethan resin and the cellulose resin is 5:95 to 95:5 (polyurethane resin:cellulose resin), or preferably 5:95 to 50:50 (polyurethane resin : cellulose resin), in terms of mass.

### Vinyl Chloride Resin

For the vinyl chloride resin, a vinyl chloride-vinyl acetate copolymer, vinyl chloride-acrylic copolymer, etc., may be used.
Vinyl chloride-vinyl acetate copolymer

For the vinyl chloride-vinyl acetate copolymer, one manufactured according to any known method may be used that comprises a vinyl chloride monomer and a vinyl acetate monomer—both traditionally used in gravure printing ink compositions—as essential components, and if necessary, also comprises fatty acid vinyl monomers such as vinyl propionate, vinyl monochloroacetate, vinyl versatate, vinyl laurate, vinyl stearate, and vinyl benzoate, or monomers having hydroxyl groups or other functional groups, as copolymerization components.

Such vinyl chloride-vinyl acetate copolymer having hydroxyl groups is obtained by partially saponifying the acetate ester part and introducing a (meth)acrylic monomer having hydroxyl groups.

With a vinyl chloride-vinyl acetate copolymer having hydroxyl groups, obtained by partially saponifying the acetate ester part, the resin film properties and solution behaviors are determined according to the ratio of the constituent unit based on the vinyl chloride reaction site (Formula 1 below), constituent unit based on the vinyl acetate reaction site (Formula 2 below), and constituent unit based on the saponification of the vinyl acetate reaction site (Formula 3 below), in its molecule. To be specific, the constituent unit based on the vinyl chloride reaction site adds strength and hardness to the resin film, the constituent unit based on the vinyl acetate reaction site adds adhesive property and flexibility, and the constituent unit based on the saponification of the vinyl acetate reaction site adds good solubility in organic solvents to the ink in consideration of the environment.

—CH₂—CHCl— Formula 1

—CH₂—CH(OCOCH₃)— Formula 2

—CH₂—CH(OH)— Formula 3

It should be noted that the aforementioned vinyl chloride-vinyl acetate copolymer used in gravure printing ink compositions for label surface printing, which is part of the present invention, may have various functional groups in its molecule from the viewpoints of solubility in the organic solvent described later, and of printability.

Also, when an environmentally friendly solvent is used as the aforementioned organic solvent, preferably the aforementioned vinyl chloride-vinyl acetate copolymer has 50 to 200 mgKOH/g of hydroxyl groups. Among the commercial products representing such vinyl chloride-vinyl acetate copolymers, preferably SOLBIN A, AL, TA5R, TA2, TA3, TAO, TAOL, etc., are used, for example.
Vinyl chloride-acrylic copolymer

The vinyl chloride-acrylic copolymer is based on a copolymer of a vinyl chloride and an acrylic monomer as its primary component, where the form of copolymerization is not limited in any way. For example, the acrylic monomer may be embedded as a block, or randomly, in the main chain of the polyvinyl chloride, or it may be graft-copolymerized to the side chain of the polyvinyl chloride.

For the acrylic monomer, a (meth)acrylate ester or acrylic monomer having hydroxyl groups, etc., may be used. Examples of the (meth)acrylic ester include (meth)acrylate alkyl esters, and although the alkyl groups may be of straight-chain, branched, or cyclic type, preferably they are straight-chain alkyl groups.

For example, methyl (meth)acrylate, ethyl (meth)acrylate, propyl (meth)acrylate, butyl (meth)acrylate, pentyl (meth)acrylate, hexyl (meth)acrylate, cyclohexyl (meth)acrylate, 2-ethylhexyl (meth)acrylate, isooctyl (meth)acrylate, decyl (meth)acrylate, dodecyl (meth)acrylate, tetradecyl (meth)acrylate, hexadecyl (meth)acrylate, octadecyl (meth)acrylate, etc., can be named.

Examples of the acrylic monomer having hydroxyl groups include 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, 6-hydroxyhexyl (meth)acrylate, 8-hydroxyoctyl (meth)acrylate, and other hydroxyalkyl (meth)acrylate esters, polyethylene glycol mono(meth)acrylate, polypropylene glycol mono(meth)acrylate, 1,4-cyclohexane dimethanol mono(meth)acrylate, and other glycol mono(meth)acrylates, caprolactone-modified (meth)acrylate, hydroxyethyl acryl amide, etc.

Also, for the acrylic monomer, an acrylic monomer having functional groups other than hydroxyl groups may be used. Examples of the functional groups other than hydroxyl groups include carboxyl groups, amide bond groups, amino groups, alkylene oxide groups, etc.

Preferably the aforementioned vinyl chloride-acrylic copolymer has a mass-average molecular weight of 10000 to 70000.

Also, from the viewpoints of solubility in an environmentally friendly solvent used as the aforementioned organic solvent, and of adhesive property with respect to the base material, preferably the aforementioned vinyl chloride-acrylic copolymer has hydroxyl groups that amount to 50 to 200 mgKOH/g.

When releasing a printed layer of a gravure printing ink composition for label surface printing that does not contain vinyl chloride resin, the ratio by mass of the solids content of polyurethane resin and cellulose resin in the gravure printing ink composition for label surface printing is 5:95 to 95:5 (polyurethane resin:cellulose resin), or preferably 10:90 to 90:10 (polyurethane resin:cellulose resin), or more preferably 20:80 to 80:20 (polyurethane resin:cellulose resin), or yet more preferably 30:70 to 70:30 (polyurethane resin:cellulose resin), or most preferably 35:65 to 65:35 (polyurethane resin:cellulose resin).

When releasing a printed layer of a gravure printing ink composition for label surface printing that contains a vinyl chloride resin, the gravure printing ink composition for label surface printing is such that, in terms of the ratio by mass of the solids content of vinyl chloride resin and urethane resin, the vinyl chloride resin is contained by 1.73 parts by mass or less relative to 1.00 part by mass of urethane resin. In particular, it is contained preferably by 1.50 parts by mass or less relative to 1.00 part by mass of urethane resin, or more preferably by 1.20 parts by mass or less relative to 1.00 part by mass of urethane resin, or most preferably by 1.00 part by mass or less relative to 1.00 part by mass of urethane resin.

### Other Binder Resins That Can Be Used Concurrently

Examples of binder resins that can be used concurrently include polyamide resins, acrylic resins, etc.

### Polyamide Resins

Polyamide resins are obtained by causing an acid component which is primarily a polymerized fatty acid but may partially contain an aliphatic, alicyclic, or aromatic dicarboxylic acid, or aliphatic monocarboxylic acid, to react with an amine component which is primarily an aliphatic, alicyclic, aromatic-aliphatic, or aromatic polyamine, or a mixture of such polyamines but may partially contain a primary or secondary monoamine.

Here, the polymerized fatty acid is obtained generally by polymerizing an unsaturated fatty acid with carbon number 16 to 22 or ester thereof, and examples include monobasic fatty acids, dimerized/polymerized fatty acids, trimerized/polymerized fatty acids, etc. Also, the aliphatic dicarboxylic acid may be succinic acid, adipic acid, azelaic acid, maleic acid, etc., the alicyclic dicarboxylic acid may be cyclohexane dicarboxylic acid, etc., and the aromatic dicarboxylic acid may be isophthalic acid, terephthalic acid, etc. Furthermore, the aliphatic monocarboxylic acid may be acetic acid, stearic acid, oleic acid, linoleic acid, etc.

On the other hand, the aliphatic polyamines that may be contained in the amine component include ethylene diamine, propylene diamine, hexamethylene diamine, methylaminopropylamine, and other aliphatic diamines, as well as diethylene triamine, triethylene tetramine, and other aliphatic polyamines, while the alicyclic polyamines include cyclohexylene diamine, isophorone diamine, etc. Also, the aromatic-aliphatic polyamines include xylylene diamine, while the aromatic polyamines include phenylene diamine, diaminodiphenylmethane, etc. Furthermore, the primary and secondary monoamines include butylamine, octylamine, diethylamine, monoethanolamine, monopropanolamine, diethanolamine, dipropanolamine, etc.

In terms of oil resistance, heat resistance, and vinyl chloride blocking resistance of the ink composition, among the polyamide resins, preferably a polyamide resin that uses alkanolamine as its primary or secondary monoamine component and contains hydroxyl groups in its molecule is used.

Regarding the method for synthesizing a polyamide resin from the acid component and amine component above, desirably the ratio of carboxyl groups/amino groups in the reacting components is 0.9/1.0 to 1.0/0.9 or preferably 1.0/1.0, the reaction temperature is 160 to 280° C. or preferably 180 to 230° C., and the final stage involves reaction under a reduced pressure of approx. 100 torr.

### Thermoplastic Polyamide Resins Using Vegetable Oil Fatty Acid as Reaction Material

The aforementioned polyamide resins include thermoplastic polyamide resins using vegetable oil fatty acid as reaction material, which are not limited in any way. For example, thermoplastic polyamide resins using vegetable oil fatty acid as reaction material include polyamide resins, etc., that use tall oil, rice bran oil, palm oil, coconut oil, soybean oil or other vegetable oil fatty acid as a reaction material. When a vegetable oil fatty acid is used as a reaction material, the environmental burden from using the resulting thermoplastic polyamide resin can be reduced.

A thermoplastic polyamide resin using vegetable oil fatty acid as reaction material is a polycondensation product of a polycarboxylic acid containing vegetable oil fatty acid and a polyamine. The polyamine is not limited in any way. For example, the polyamine may be an aliphatic polyamine, alicyclic polyamine, aromatic polyamine, etc. The aliphatic polyamine may be ethylene diamine, diethylene triamine, triethylene tetramine, tetraethylene pentaamine, pentaethylene hexane, piperazine, N-aminoethyl piperazine, etc. The alicyclic polyamine may be isophorodiamine, bisaminomethylcyclohexane, etc. The aromatic polyamine may be methaxylenediamine, etc. Multiple thermoplastic polyamide resins may be used in combination.

The number-average molecular weight (Mn) of the thermoplastic polyamide resin is not limited in any way. For example, preferably the Mn of the thermoplastic polyamide resin is 1000 or higher. Also, preferably the Mn is 30000 or lower. When the Mn of the thermoplastic polyamide resin is lower than 1000, the ink composition tends to have lower blocking resistance and heat resistance. When the Mn exceeds 30000, on the other hand, the ink composition tends to have lower crumpling resistance.

The acid value and amine value of the thermoplastic polyamide resin are not limited in any way. For example, preferably the thermoplastic polyamide resin has an acid value of 10 or lower and an amine value of 5 or lower.

More preferably the thermoplastic polyamide resin has a softening point of 90 to 150° C.

The content of the thermoplastic polyamide resin is not limited in any way. For example, the content of the thermoplastic polyamide resin is preferably 20 percent by mass or higher, and preferably 70 percent by mass or lower, relative to the total solids content in the ink composition.

### Acrylic Resins

Acrylic resins can be manufactured by any traditionally known method, and their manufacturing method is not limited in any way. Acrylic resins are obtained by polymerizing a monomer having carbon-carbon unsaturated double bonds per molecule, in a solvent in the presence of a polymerization initiator.

Here, the monomer having carbon-carbon unsaturated double bonds per molecule may be a (i) (meth)acrylic acid derivative, (ii) aromatic vinyl, (iii) olefin hydrocarbon, (iv) vinyl ester, (v) vinyl halide, (vi) vinyl ether, etc.

The (i) (meth)acrylic acid derivative may be (meth)acrylonitrile, (meth)acrylate, methyl (meth)acrylate, butyl (meth)acrylate, ethylhexyl (meth)acrylate, stearyl (meth)acrylate, or other alkyl (meth)acrylate, benzyl (meth)acrylate, etc.

The (ii) aromatic vinyl may be styrene, methyl styrene, ethyl styrene, chlorostyrene, monofluoromethyl styrene, difluoromethyl styrene, trifluoromethyl styrene, or other styrene whose hydrogen has been partially replaced with fluorine.

The (iii) olefin hydrocarbon may be ethylene, propylene, butadiene, isobutylene, isoprene, 1,4-pentadiene, etc.

The (iv) vinyl ester may be vinyl acetate, etc.

The (v) vinyl halide may be vinyl chloride, vinylidene chloride, etc.

The (vi) vinyl ether may be vinyl methyl ether, etc.

Also, for the monomer having carbon-carbon unsaturated double bonds per molecule, a monomer having crosslinkable functional groups may be used. The monomer having functional groups may be a (vii) monomer having hydroxyl groups, (viii) monomer having isocyano groups, (ix) monomer having epoxy groups, etc.

The (vii) monomer having hydroxyl groups may be 2-hydroxyethyl (meth)acrylate, 1-hydroxypropyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, or other hydroxyalkyl (meth)acrylate, polyethylene glycol mono(meth)acrylate, polypropylene glycol mono(meth)acrylate, polytetramethylene glycol mono(meth)acrylate, or other glycol mono(meth)acrylate, hydroxy styrene, etc.

The (viii) monomer having isocyano groups may be one obtained by causing (meth)acryloyloxyethyl isocyanate, (meth)acryloyloxypropyl isocyanate, or 2-hydroxyethyl (meth)acrylate, 4-hydroxybutyl (meth)acrylate, or other hydroxyalkyl (meth)acrylate, to react with toluene diisocyanate, isophorone diisocyanate or other polyisocyanate.

The (ix) monomer having epoxy groups may be glycidyl methacrylate, glycidyl cinnamate, glycidyl allyl ether, glycidyl vinyl ether, vinyl cyclohexane monoepoxide, 1,3-butadiene monoepoxide, etc.

If necessary, one or more types of monomer having carbon-carbon unsaturated double bonds in its molecule may be selected from the foregoing, or two or more types may be mixed and used together, where preferably the acid value is 100 to 200. If the acid value is outside this range, the ink experiences phase separation, rising viscosity, or gelation, and presents preservation stability problems.

For the polymerization initiator used in the synthesis of acrylic resin, any normal peroxide or azo compound, such as benzoyl peroxide, azo-isobutyl valeronitrile, azo-bis-isobutyronitrile, di-t-butyl peroxide, t-butyl perbenzoate, t-butyl peroctoate, cumene hydroxyperoxide, etc., may be used, where the polymerization temperature is 50 to 140° C., or preferably 70 to 140° C.

Preferably the weight-average molecular weight of the obtained polymer is 5000 to 100000.

For the non-aromatic solvent used in the aforementioned manufacturing method, acetone, methyl ethyl ketone, methyl isobutyl ketone, cyclohexanone, or other ketone, tetrahydrofuran, dioxane, ethylene glycol dimethyl ether, diethylene glycol dimethyl ether, or other ether, ethyl acetate, butyl acetate, or other ester, etc., can be used. The solvent may be a mixture of two or more types of solvents.

### Other Resins

Furthermore, rosin resin, dimer acid resin, maleic acid resin, petroleum resin, terpen resin, ketone resin, dammar resin, copal resin, chlorinated polypropylene, polypropylene oxide, etc., may be used, as necessary. When any of these hard resins is used, the adhesive property with respect to resin films, especially those that are not surface-treated, is expected to improve. And, when the gravure printing ink composition for label surface printing under the present invention is to contain a hard resin, its appropriate content is lower than 5.0 percent by mass.

### Additives

### Chelate Crosslinking Agent

As a chelate crosslinking agent, any metal chelate crosslinking agent, such as titanium chelate or zirconium chelate, may be used.

Examples of titanium chelates include tetraisopropyl titanate; tetranormalbutyl titanate; butyl titanate dimer; tetra(2-ethylhexyl) titanate; reaction product of tetraisopropoxy titanium and 2-ethylhexanoic acid; tetramethyl titanate, titan alkoxide such as tetrastearyl titanate; triethanolamine titanate; titanium acetyl acetate; titanium ethyl acetoacetate; titanium lactate; octylene glycol titanate; titanium tetraacetyl acetonate; titanium n-butyl phosphate ester; propane dioxytitanium bis(ethylacetyl acetate); and other titanium chelates.

Examples of zirconium chelates include zirconium propionate, zirconium acetyl acetate, etc.

From the environmental viewpoint, preferred among other chelate crosslinking agents is a chelate crosslinking agent that has no acetyl acetonate as a ligand, so that acetylacetone will not generate following the crosslinking reaction.

### Fatty Acid Amide

A fatty acid amide is used from the viewpoint of blocking resistance. Fatty acid amides include saturated fatty acid amides, unsaturated fatty acid amides, modified fatty acid amides, etc., among which use of modified fatty acid amides is particularly preferable in order to improve the blocking resistance on soft polyvinyl chloride sheets used for table cloths. If a fatty acid amide is to be contained, its content is preferably 0.1 to 3.0 percent by mass, or more preferably 0.5 to 2.0 percent by mass, in the gravure printing ink composition.

When the content is lower than 0.1 percent by mass, the blocking resistance may drop, while a content exceeding 3.0 percent by mass may cause the oil resistance to drop.

### Organic Solvent

Preferably the organic solvent is one free from aromatic hydrocarbon-based organic solvent in consideration of the environment. Organic solvents free from aromatic hydrocarbon-based organic solvent primarily include methanol, ethanol, n-propanol, isopropanol, butanol, and other alcohol-based organic solvents; acetone, methyl ethyl ketone, methyl isobutyl ketone, and other ketone-based organic solvents; methyl acetate, ethyl acetate, propyl acetate, butyl acetate, and other ester-based organic solvents; n-hexane, n-heptane, n-octane, and other aliphatic hydrocarbon-based organic solvents; and cyclohexane, methylcyclohexane, ethylcyclohexane, cycloheptane, cyclooctane, and other alicyclic hydrocarbon-based organic solvents; where the foregoing may be mixed and used together in consideration of the solubility of the binder resin, drying property, and so on. It should be noted that, in consideration of the environment, preferably ketone-based organic solvents should be avoided, among the aforementioned organic solvents, if all possible.

In terms of use quantity, such organic solvent is contained by 15.0 percent by mass or more in the gravure printing ink composition under the present invention in consideration of printability. Also, from the viewpoint of printability, propyl acetate is contained preferably by 5.0 percent by mass or more, or more preferably by 10.0 percent by mass or more, in the ink composition. Also, to improve the printability, preferably the organic solvent contains water by 0.1 to 10 percent by mass.

### Additives That May be Added if Necessary

For the purpose of improving the friction resistance, a wax may be added to the extent that the performance will not drop.

For the wax, polyolefin wax, paraffin wax, or any of various types of known waxes may be used.

Furthermore, various types of ink additives, such as pigment dispersant, leveling agent, surface-active agent, and plasticizer, may be added at will.

### Method for Manufacturing Ink Composition

Regarding the method for manufacturing an ink composition using the foregoing materials, a usable method is one whereby the pigment, binder resin, organic solvent, and if necessary, pigment dispersant, surface-active agent, etc., are mixed under agitation first, and then kneaded using any of various types of kneaders, such as a bead mill, ball mill, sand mill, attritor, roll mill, pearl mill, etc., followed by, if necessary, adding and mixing of the fatty acid amide, chelate crosslinking agent, and remaining materials.

The ink composition obtained from the above materials and manufacturing method can be printed using the standard gravure method.

### Printed Matter

Next, the printed matter based on the ink composition is explained in specific details.

Preferably the base material to be printed on is a resin film. Resin films for this purpose include polyester and other films, shrink polyester films, etc. Furthermore, each of these resin films may be one obtained by pre-treating a resin film by coating or kneading in an antifogging agent, surface-coating, or kneading in a matting agent, or the like.

The printed matter under the present invention is obtained, for example, by gravure-printing the aforementioned resin film in the form of single-color printing or multi-color overprinting using an ink composition(s) as prepared according to the above, and then drying it with a dryer. And, an appropriate quantity of the ink film to be formed as a result of the printing is 0.1 to 2.0 g/m² in application quantity based on dry film.

### Method for Releasing Ink Composition from Printed Matter

From the printed matter comprising a film whose top or bottom surface has been printed with the gravure printing ink composition for label surface printing under the present invention, without receiving further treatment (printed matter having no laminate layer, etc., layered on its ink composition layer), the layer of the ink composition is released to separate the base material and the ink composition. For this method, a means of cutting the printed matter into thin strips using an arbitrary means, and then immersing the strips in an alkali release solution being an alkaline aqueous solution containing a basic compound such as sodium hydroxide or potassium hydroxide and a polyoxyalkylene alkyl derivative, while agitating if necessary, may be adopted. Here, the concentration of the sodium hydroxide or potassium hydroxide is preferably 0.5 to 15 percent by mass, or more preferably 1.0 percent by mass or higher, or yet more preferably 1.5 percent by mass or higher. In the meantime, it is preferably 5.0 percent by mass or lower in consideration of treatment of the effluent after use, or more preferably 3.0 percent by mass or lower. Also, the content of the polyoxyalkylene alkyl derivative only needs to be in a range that allows the effect of containing the polyoxyalkylene alkyl derivative to be demonstrated fully, which is preferably 0.01 to 3.0 percent by mass, or more preferably 0.5 to 2.0 percent by mass.

At the time of release, the alkali release solution may be at room temperature of approx. 25° C., or it may be heated to between 25 and 90° C. Furthermore, its temperature may be 30° C. or higher.

The immersion time is preferably 1 minute to 12 hours, or more preferably no longer than 1 hour, or yet more preferably no longer than 30 minutes, or most preferably no longer than 10 minutes.

At the same time, preferably the fragments of the printed matter are treated with a large enough quantity of alkali release solution equivalent to 100 to 1,000,000 times the mass of the printed matter to facilitate the release.

When the base material of the printed matter is a polyester, for example, this release method allows the printed layer by the ink composition to be removed in the alkali release solution, so that the separated polyester can be washed in water and dried to obtain a recycled polyester base material. Also, the recycled polyester base material may be reformed into, and utilized as, pellets using an extrusion machine.

For example, the following alkali release solution may be used.

### Alkali Release Solution

An alkali release solution containing water, a basic compound, and a polyoxyalkylene alkyl derivative, may be used. For the basic compound, sodium hydroxide, potassium hydroxide, or other alkali metal hydroxide, etc., may be utilized, where the concentration of the alkali metal hydroxide in the alkali release solution is preferably 0.5 to 15 percent by mass, or more preferably 1 to 5 percent by mass. So long as the concentration remains within the aforementioned range, the alkali release solution can maintain enough alkalinity required for releasing. It should be noted that, from the viewpoints of environmental consideration and handling of effluent in the recycling process, preferably the concentration of the alkali metal hydroxide is 5.0 percent or lower.

For the polyoxyalkylene alkyl derivative, a polyoxyalkylene alkyl phenyl ether, or specifically polyethylene glycol (10), poly(oxyethylene) nonyl phenyl ether, etc., may be used.

Preferably the use quantity of the polyoxyalkylene alkyl derivative in the alkali release solution is 0.05 to 3 percent by mass.

### EXAMPLES

The present invention is explained in greater detail below by citing examples; however, the present invention is not limited to these examples. It should be noted that, unless otherwise specified, “%” represents “percent by mass,” while “part(s)” represents “part(s) by mass.”

### Gravure Ink Composition

### Printing Ink Composition to Be Released

Pigment: Carbon black, pigment red 145

### Polyurethane Resin Varnish

One hundred parts by mass of 3-methyl-1,5-pentylene adipate diol of 2000 in average molecular weight, 100 parts by mass of polypropylene glycol of 2000 in average molecular weight, and 44.4 parts by mass of isophorone diisocyanate were placed in a four-way flask equipped with an agitator, a cooling tube, and a nitrogen gas introduction tube, and reacted for 6 hours at 100 to 105° C. under nitrogen gas introduction. After the flask was let cool to near room temperature and 644 parts by mass of ethyl acetate and 146 parts by mass of isopropyl alcohol were added, 15.6 parts by mass of isophoronediamine were added to extend the chain and 0.31 parts by mass of monoethanolamine were added further to be reacted, after which 2.18 parts by mass of isophoronediamine and 0.17 parts by mass of diethylenetriamine were added to stop the reaction, to obtain a polyurethane resin varnish (25 percent by mass in solids content).

### Nitrocellulose Solution 1

Thirty-seven parts by mass of nitrocellulose (NC RS-2 KCNC, manufactured by KOREA CNC LTD.) were dissolved in a mixed solvent constituted by 8 parts by mass of isopropyl alcohol, 43 parts by mass of ethyl acetate, and 12 parts by mass of normal propyl acetate, to obtain a nitrocellulose solution of 37 percent by mass in solids content.

### Nitrocellulose Solution 2

Twenty-nine parts by mass of nitrocellulose (NC RS-2 KCNC, manufactured by KOREA CNC LTD.) were dissolved in a mixed solvent constituted by 43 parts by mass of normal propyl alcohol and 28 parts by mass of normal propyl acetate, to obtain a nitrocellulose solution of 29 percent by mass in solids content.

### Vinyl Chloride/Vinyl Acetate Copolymer Solution

Seventy-five parts by mass of vinyl chloride/vinyl acetate copolymer (product name: SOLBIN TASR, manufactured by Nissin Chemical Industry Co., Ltd.) were dissolved in 25 parts by mass of ethyl acetate, to obtain a vinyl chloride/vinyl acetate copolymer solution of 75 percent by mass in solids content.

### Cellulose Acetate Butyrate Solution

Twenty parts by mass of cellulose acetate butyrate (manufactured by Eastman Chemical Company, 70000 in number-average molecular weight, 35 to 39% butyrylated) were dissolved in 80 parts by mass of normal propyl acetate, to obtain a cellulose acetate butyrate solution of 20 percent by mass in solids content.

### Polyethylene Wax

Clariant Ceridust 3715

### Polymerized Rosin

Polymerized rosin of 165 mgKOH/g in acid value

### Fatty Acid Amide

Dehydrated castor oil fatty acid amide (WAM-2000N) NPA: n-propyl alcohol solution

### Preparation of Ink Compositions

The respective materials were kneaded together with a paint conditioner according to the mass percentages (percent by mass) in Tables 1 and 2 below, to prepare ink compositions. Also, the obtained ink compositions were gravure-printed under the conditions below. The obtained printed matters were evaluated for adhesive property and release property according to the evaluation methods below.

### Ink Release Test Method

### Preparation of Printed Matter

To each of the ink compositions obtained per Tables 1 and 2, an 80/20 mixed solvent of normal propyl acetate and isopropyl alcohol was further added to dilute the ink composition to 16 seconds in Zahn-Viscosity Cup No. 3 manufactured by Rigosha & Co., Ltd. This diluted ink composition was coated on a crystallizable shrink PET (polyethylene terephthalate) film using a bar coater of 0.15 mm in wire diameter, to obtain an ink composition-transferred film. This ink composition-transferred film was taken by 1.5 g and shredded to small strips of approx. MD 15 mm×TD 25 mm, to obtain an ink release test sample.

### Preparation of Alkali Release Solution 1

One part by mass of sodium hydroxide and 0.3 parts by mass of Triton X-100 surface-active agent manufactured by Sigma-Aldrich Co. (polyethylene glycol p-(1,1,3,3-tetramethyl butyl)-phenyl ether) were added to, and dissolved under agitation in, 98.7 parts by mass of water, to obtain alkali release solution 1.

### Preparation of Alkali Release Solution 2

One part by mass of sodium hydroxide was added to, and dissolved under agitation in, 99.0 parts by mass of water, to obtain alkali release solution 2.

### Alkali Release

One hundred grams of each of the aforementioned alkali release solutions was put in a HDPE (high-density polyethylene) container of 200 cc in capacity, and heated in a hot-water bath to a solution temperature of 85° C.

Once the release solution has reached 85° C., the aforementioned ink release test sample was introduced into the release solution and agitated for 15 minutes using stainless steel agitation blades of 25 mm in blade diameter. Following the agitation, the HDPE container was removed from the hot-water bath and let stand for 5 minutes at room temperature. The release solution and shrink PET (polyethylene terephthalate) film pieces were separated using a stainless-steel sieve with a mesh opening size of approx. 2 mm.

It should be noted that Comparative Examples B3 to 7 released in alkali release solution 2 mentioned above, while all other Examples and Comparative Examples released in alkali release solution 1 mentioned above.

As for the degree of coloring of the release solution, “◯” was given when no coloring was observed, “Δ” was given when moderate coloring was observed, and “×” was given when significant coloring was observed. Also, the state of the released ink in the release solution was visually evaluated. “◯” was given when the ink coating layer remained in layer state in the release solution, “Δ” was given when the ink coating layer was half dissolved and half remained in layer state, and “×” was given when the ink coating layer had resolved or was suspended completely in the release solution.

### Rinsing

The shrink PET film undergoing alkali release was transferred into a 200-cc HDPE container and 100 g of water was added. The mixture was agitated for 5 minutes using stainless steel agitation blades. The mixture was let stand for 5 minutes, after which the shrink PET film pieces and water were separated using a stainless-steel sieve. The shrink PET film pieces were dried and then visually evaluated for ink release property from the shrink PET film and also for size of the released ink layer.

“◯” was given when the ink had released completely from the shrink PET film, “Δ” was given when around a half of the ink had released, and “×” was given when the ink did not release at all.

Also, reattachment of the released ink layer to the shrink PET film, or absence thereof, was visually evaluated.

“◯” was given when there was no reattachment, while “×” was given when reattachment was observed.

Regarding the degree of coloring of the shrink PET film, “◯” was given when there was no coloring, “Δ” was given when there was moderate coloring, and “×” was given when there was significant coloring.

TABLE 1

| | Example | Comparative Example | | Example | | |
|---|---|---|---|---|---|---|
| | A1 | A1 | A2 | A2 | A3 | A4 |
| Urethane resin | 26.7 | 20.0 | 24.0 | 28.0 | 28.0 | 24.0 |
| varnish (25% in | | | | | | |
| solids content) | | | | | | |
| Nitrocellulose | 7.7 | | | | | |
| solution 1 (37% in | | | | | | |
| solids content) | | | | | | |
| Nitrocellulose | | 5.0 | 5.0 | 5.0 | | |
| solution 2 (29% in | | | | | | |
| solids content) | | | | | | |
| Vinyl | | 18.0 | 14.0 | 10.0 | | |
| chlonde/vinyl | | | | | | |
| acetate copolymer | | | | | | |
| solution (75% in | | | | | | |
| solids content) | | | | | | |
| Cellulose acetate | | | | | 15.0 | 20.0 |
| butyrate solution | | | | | | |
| (20% in solids | | | | | | |
| content) | | | | | | |
| Polyethylene wax | 3.5 | 1.3 | 1.3 | 1.3 | 3.0 | 3.0 |
| Polymerized rosin | | 0.5 | 0.5 | 0.5 | | |
| Dehydrated castor | | 1.0 | 1.0 | 1.0 | 1.0 | 1.0 |
| oil fatty acid | | | | | | |
| amide/NPA = 50/50 | | | | | | |
| Titanium oxide | 30.0 | 30.0 | 30.0 | 30.0 | 30.0 | 30.0 |
| Ethyl acetate | 13.5 | | | | | |
| Normal propyl | 8.5 | 20.2 | 20.2 | 20.2 | 16.0 | 14.0 |
| acetate | | | | | | |
| Normal propyl | 1.5 | 2.0 | 2.0 | 2.0 | 4.5 | 5.5 |
| alcohol | | | | | | |
| Ethanol | 6.1 | | | | | |
| Water | 2.5 | 2.0 | 2.0 | 2.0 | 2.5 | 2.5 |
| Total | 100.0 | 100.0 | 100.0 | 100.0 | 100.0 | 100.0 |
| Adhesion of ink to | ∘ | ∘ | ∘ | ∘ | ∘ | ∘ |
| shrink PET film | | | | | | |
| Release of ink | ∘ | x | Δ | ∘ | ∘ | ∘ |
| Coloring of cPET | ∘ | Did not | Did not | ∘ | ∘ | ∘ |
| film | | release | release | | | |
| | | | sufficiently | | | |
| Coloring of alkali | ∘ | ∘ | ∘ | ∘ | ∘ | ∘ |
| release solution | (Suspended) | | | | | |
| State of ink layer | x | Did not | Did not | Δ (Half | ∘ | ∘ |
| after release (Size | (Dissolved, | release | release | dissolved, | (Undissolved, | (Undissolved, |
| of ink pieces) | suspended) | | sufficiently | very | small) | small to |
| | | | | small) | | medium) |
| Reattachment of | ∘ | Did not | Did not | x | ∘ | ∘ |
| released ink layer | | release | release | | | |
| to PET film | | | sufficiently | | | |

| | Example | | |
|---|---|---|---|
| | A5 | A6 | A7 |
| Urethane resin varnish | 20.0 | 16.0 | 20.0 |
| (25% in solids content) | | | |
| Nitrocellulose solution 1 | | | |
| (37% in solids content) | | | |
| Nitrocellulose solution 2 | | | |
| (29% in solids content) | | | |
| Vinyl chloride/vinyl acetate | | | |
| copolymer solution (75% in | | | |
| solids content) | | | |
| Cellulose acetate butyrate | 25.0 | 30.0 | 25.0 |
| solution (20% in solids content) | | | |
| Polyethylene wax | 3.0 | 3.0 | 3.0 |
| Polymerized rosin | | | |
| Dehydrated castor oil fatty | 1.0 | 1.0 | 1.0 |
| acid amidc/NPA = 50/50 | | | |
| Titanium oxide | 30.0 | 30.0 | 30.0 |
| Ethyl acetate | | | |
| Normal propyl acetate | 12.0 | 10.0 | 12.5 |
| Normal propyl alcohol | 6.5 | 7.5 | 6.0 |
| Ethanol | | | |
| Water | 2.5 | 2.5 | 2.5 |
| Total | 100.0 | 100.0 | 100.0 |
| Adhesion of ink to shrink | Δ~∘ | Δ | ∘ |
| PET film | | | |
| Release of ink | ∘ | ∘ | ∘ |
| Coloring of cPET film | ∘ | ∘ | ∘ |
| Coloring of alkali release | ∘ | ∘ | ∘ |
| solution | | | |
| State of ink layer after | ∘ | ∘ | ∘ |
| release (Size of ink | (Undissolved, | (Undissolved, | (Undissolved, |
| pieces) | medium) | medium to | medium) |
| | | large) | |
| Reattachment of released ink | ∘ | ∘ | ∘ |
| layer to PET film | | | |

TABLE 2

| | | | Comparative | Comparative | |
|---|---|---|---|---|---|
| | Example B1 | Example B2 | Example B1 | Example B2 | Example B3 |
| Urethane resin varnish | 32.0 | 28.0 | 24.0 | 20.0 | 26.0 |
| (25% in solids content) | | | | | |
| Vinyl chloride/vinyl | 12.0 | 16.0 | 20.0 | 24.0 | 10.0 |
| acetate copolymer | | | | | |
| varnish (75% in solids | | | | | |
| content) | | | | | |
| Normal propyl acetate | 31.2 | 31.2 | 31.2 | 31.2 | 35.4 |
| Pigment: PR146 | 13.0 | 13.0 | 13.0 | 13.0 | 13.0 |
| Normal propyl alcohol | 6.8 | 6.8 | 6.8 | 6.8 | 5.8 |
| Propylene glycol | 3.0 | 3.0 | 3.0 | 3.0 | 3.0 |
| monomethyl ether | | | | | |
| acetate | | | | | |
| Nitrocellulose solution | | | | | 5.0 |
| 2 (29% in solids | | | | | |
| content) | | | | | |
| Modified polymerized | 0.5 | 0.5 | 0.5 | 0.5 | 0.5 |
| rosin of acid value 165 | | | | | |
| Dehydrated castor oil | 0.5 | 0.5 | 0.5 | 0.5 | 0.5 |
| fatty acid amide/NPA = | | | | | |
| 50/50 | | | | | |
| Water | 1.0 | 1.0 | 1.0 | 1.0 | 0.8 |
| Total | 100.0 | 100.0 | 100.0 | 100.0 | 100.0 |
| Adhesion of ink | ∘ | ∘ | ∘ | ∘ | ∘ |
| Release of ink | ∘ | ∘ | Δ | x | ∘ |
| Coloring of cPET film | ∘ | ∘ | Did not | Did not | ∘ |
| | | | release | release | |
| | | | sufficiently | | |
| Coloring of alkali | ∘− | ∘− | ∘− | ∘− | ∘− |
| release solution | | | | | |
| State of ink layer after | ∘ | ∘ | Did not | Did not | ∘ |
| release (Size of ink | (Undissolved, | (Undissolved, | release | release | (Undissolved, |
| pieces) | medium) | medium) | sufficiently | | small to |
| | | | | | medium) |
| Reattachment of | ∘ | ∘ | Did not | Did not | ∘ |
| released ink layer to | | | release | release | |
| PET film | | | sufficiently | | |

| | Comparative | Comparative | Comparative | Comparative | Comparative |
|---|---|---|---|---|---|
| | Example B3 | Example B4 | Example B5 | Example B6 | Example B7 |
| Urethane resin varnish | 32.0 | 28.0 | 24.0 | 20.0 | 26.0 |
| (25% in solids content) | | | | | |
| Vinyl chloride/vinyl | 12.0 | 16.0 | 20.0 | 24.0 | 10.0 |
| acetate copolymer | | | | | |
| varnish | | | | | |
| (75% in solids content) | | | | | |
| Normal propyl acetate | 31.2 | 31.2 | 31.2 | 31.2 | 35.4 |
| Pigment: PR146 | 13.0 | 13.0 | 13.0 | 13.0 | 13.0 |
| Normal propyl alcohol | 6.8 | 6.8 | 6.8 | 6.8 | 5.8 |
| Propylene glycol | 3.0 | 3.0 | 3.0 | 3.0 | 3.0 |
| monomethyl ether | | | | | |
| acetate | | | | | |
| Nitrocellulose solution 2 | | | | | 5.0 |
| (29% in solids content) | | | | | |
| Modified polymerized | 0.5 | 0.5 | 0.5 | 0.5 | 0.5 |
| rosin of acid value 165 | | | | | |
| Dehydrated castor oil | 1 | 1 | 1 | 1 | 1 |
| fatty acid amide/NPA = | | | | | |
| 50/50 | | | | | |
| Water | 1.0 | 1.0 | 1.0 | 1.0 | 0.8 |
| Total | 100.0 | 100.0 | 100.0 | 100.0 | 100.0 |
| Adhesion of ink | ∘ | ∘ | ∘ | ∘ | ∘ |
| Release of ink | Δ | Δ | x | x | Δ |
| Coloring of cPET film | Did not | Did not | Did not | Did not | Did not |
| | release | release | release | release | release |
| | sufficiently | sufficiently | | | sufficiently |
| Coloring of alkali release | ∘− | ∘− | ∘− | ∘− | ∘− |
| solution | | | | | |
| State of ink layer after | Did not | Did not | Did not | Did not | Did not |
| release (Size of ink | release | release | release | release | release |
| pieces) | sufficiently | sufficiently | | | sufficiently |
| Reattachment of released | Did not | Did not | Did not | Did not | Did not |
| ink layer to PET film | release | release | release | release | release |
| | sufficiently | sufficiently | | | sufficiently |

Examples A1 to A7 and B1 to B3 represent examples conforming to the present invention, and their results show that the layer of each ink composition released in sufficiently large pieces when treated in alkali release solution 1. This means that the ink composition layer and base material can be separated effortlessly by means of simple filtration or other separation means so that each can be reused with ease.

However, according to Comparative Examples A1 and 2, each adopting a gravure printing ink composition for label surface printing that does not satisfy requirement b of the present invention, the layer of each ink composition could not be released sufficiently using alkali release solution 1 of the present invention.

Also, according to Comparative Examples B3 to B7, each using alkali release solution 2 not containing polyoxyalkylene alkyl derivative, it could not be released sufficiently.

1. An alkali release solution comprising a basic compound, a polyoxyalkylene alkyl derivative, and water, for releasing a printed layer formed on a base material and constituted by a gravure printing ink composition for label surface printing that satisfies a or b below:
a) when the gravure printing ink composition for label surface printing does not contain vinyl chloride resin,
it is a gravure printing ink composition for label surface printing that contains a pigment, a binder resin containing cellulose resin and urethane resin, and an organic solvent, wherein a ratio by mass of solids content of polyurethane resin and cellulose resin is 5/95 to 95/5 (polyurethane resin: cellulose resin); or
b) when the gravure printing ink composition for label surface printing contains a vinyl chloride resin,
it is a gravure printing ink composition for label surface printing that contains a pigment, a vinyl chloride resin, and a polyurethane resin, wherein a content of the vinyl chloride resin, based on a ratio by mass of solids content of vinyl chloride resin and urethane resin, is 1.73 parts by mass or lower relative to the urethane resin representing 1.00 part by mass.

2. The alkali release solution for gravure printing ink compositions for label surface printing according to claim 1, wherein the polyoxyalkylene alkyl derivative is a polyoxyalkylene alkyl phenyl ether.

3. The alkali release solution according to claim 1, wherein the basic compound is contained by 0.5 to 15.0 percent by mass and the polyoxyalkylene alkyl derivative is contained by 0.01 to 3.0 percent by mass.

4. The alkali release solution according to claim 2, wherein the basic compound is contained by 0.5 to 15.0 percent by mass and the polyoxyalkylene alkyl derivative is contained by 0.01 to 3.0 percent by mass.

5. A release method for releasing a printed layer formed on a shrink PET base material and constituted by a gravure printing ink composition for label surface printing that satisfies a or b below, using an alkali release solution containing a basic compound, a polyoxyalkylene alkyl derivative, and water:
a) when the gravure printing ink composition for label surface printing does not contain vinyl chloride resin,
it is a gravure printing ink composition for label surface printing that contains a pigment, a binder resin containing cellulose resin and urethane resin, and an organic solvent, wherein a ratio by mass of solids content of polyurethane resin and cellulose resin is 5/95 to 95/5 (polyurethane resin:cellulose resin); or
b) when the gravure printing ink composition for label surface printing contains a vinyl chloride resin,
it is a gravure printing ink composition for label surface printing that contains a pigment, a vinyl chloride resin, and a polyurethane resin, wherein a content of the vinyl chloride resin, based on a ratio by mass of solids content of vinyl chloride resin and urethane resin, is 1.73 parts by mass or lower relative to the urethane resin representing 1.00 part by mass.

6. The release method according to claim 5, wherein the polyoxyalkylene alkyl derivative is a polyoxyalkylene alkyl phenyl ether.

7. The release method according to claim 5, wherein the basic compound is contained by 0.5 to 15.0 percent by mass and the polyoxyalkylene alkyl derivative is contained by 0.01 to 3.0 percent by mass.

8. The release method according to claim 6, wherein the basic compound is contained by 0.5 to 15.0 percent by mass and the polyoxyalkylene alkyl derivative is contained by 0.01 to 3.0 percent by mass.

9. A method for releasing a printed layer formed on a shrink PET base material, comprising:
providing a shrink PET base material on which a printed layer constituted by a gravure printing ink composition is formed by label surface printing, wherein the gravure printing ink composition satisfies a) or b) below:
a) when the gravure printing ink composition does not contain vinyl chloride resin, the composition contains a pigment, a binder resin containing cellulose resin and urethane resin, and an organic solvent, wherein a ratio by mass of solids content of polyurethane resin and cellulose resin is 5/95 to 95/5 (polyurethane resin/cellulose resin); or
b) when the gravure printing ink composition contains a vinyl chloride resin, the composition contains a pigment, a vinyl chloride resin, and a polyurethane resin, wherein a content of the vinyl chloride resin, based on a ratio by mass of solids content of vinyl chloride resin and urethane resin, is 1.73 parts by mass or lower relative to the urethane resin representing 1.00 part by mass;
placing the printed layer on the shrink PET base material in an alkali release solution containing a basic compound, a polyoxyalkylene alkyl derivative, and water to release or separate the printed layer from the shrink PET bse material to the alkali release solution; and
recover the printed layer-released shrink PET base material.

10. The method according to claim 9, wherein the polyoxyalkylene alkyl derivative is a polyoxyalkylene alkyl phenyl ether.

11. The method according to claim 9, wherein the basic compound is contained by 0.5 to 15.0 percent by mass and the polyoxyalkylene alkyl derivative is contained by 0.01 to 3.0 percent by mass.

12. The method according to claim 10, wherein the basic compound is contained by 0.5 to 15.0 percent by mass and the polyoxyalkylene alkyl derivative is contained by 0.01 to 3.0 percent by mass.
